(19) United States
(12) Patent Application Publication
(10) Pub. No.: US 2013/0059933 A1
(43) Pub. Date: Mar. 7, 2013

(54) EXPANDABLE THERMALLY-STABLE STYRENE COPOLYMERS

(71) Applicants: Holger Ruckdäschel, St. Martin (DE); Alexandre Terrenoire, Sprendlingen (DE); Jan Kurt Walter Sandler, Heidelberg (DE); Klaus Hahn, Kirchheim (DE); Ingo Bellin, Mannheim (DE); Georg Grässel, Ludwigshafen (DE); Martin Weber, Maikammer (DE)

(72) Inventors: Holger Ruckdäschel, St. Martin (DE); Alexandre Terrenoire, Sprendlingen (DE); Jan Kurt Walter Sandler, Heidelberg (DE); Klaus Hahn, Kirchheim (DE); Ingo Bellin, Mannheim (DE); Georg Grässel, Ludwigshafen (DE); Martin Weber, Maikammer (DE)

(73) Assignee: BASF SE, Ludwigshafen (DE)

(21) Appl. No.: 13/599,528

(22) Filed: Aug. 30, 2012

Related U.S. Application Data
(60) Provisional application No. 61/529,296, filed on Aug. 31, 2011.

(51) Int. Cl. C08J 9/18; C08L 25/08

(52) U.S. Cl. 521/59; 521/60

(57) ABSTRACT

A process for producing an expandable pelletized polymeric material which comprises:
a) providing a polymer component, consisting of
   a styrene polymer component having a glass transition temperature of ≧130° C., formed from
and
   one or more thermoplastic polymers selected from the group consisting of aromatic polyethers; polyolefins; polyacrylates; polycarbonates; polyesters; polyamides; polyether sulfones; polyether ketones and polyether sulfides,
(b) heating the polymer component to form a polymer melt,
(c) introducing a blowing agent component into the polymer melt to form a foamable melt,
(d) homogenizing the mixture,
(f) extruding the blowing agent-containing polymer melt through a die plate,
(g) pelletizing the blowing agent-containing melt in a liquid-filled chamber to form a pelletized material.
   The expandable pelletized material is suitable for production of molded foam bodies, the applications as insulation material and as structural foam elements for lightweight construction and composite applications.

This invention relates to expandable pellets comprising thermally-stable styrene copolymers and blends of styrene copolymers, processes for production thereof, bead foams and bead foam moldings obtainable from the expandable pellets and also the use of the foams and foam moldings particularly in wind power plants.

Bead foams based on styrene copolymers are used in many sectors of the industry (see for example WO 2005/056652 and WO 2009/000872) owing to their low weight and their good insulation properties.

JP-A 2010-229205 describes producing expandable pellets wherein at least one component has a glass transition temperature of at least 110° C. The examples utilize blends of polystyrene (PS) with a comparatively more heat-resistant polymer such as SMA or PPE. Adding PS has the effect of improving foam processing properties and of reducing product costs. The production process described is a melt impregnation process with underwater pelletization.

U.S. Pat. No. 4,596,832 discloses a process for producing a thermally stable foam, comprising the steps of providing a styrene-maleic anhydride-copolymer, adding of 0.5 to 5 wt.-% of a chemical blowing agens, which is a metal carboxylate or metal carbonate, melting and homogenizing, extruding the blowing agent containing polymer melt through a die plate, pelletizing, and quenching the prefoamed pellets in water.

Although existing foams already provide good results in many sectors, it is an ever present object to improve such materials, for example with regard to solvent resistance, heat resistance, mechanical stiffness, low water imbibition and blowing agent holding capacity. And it is desired that novel developments can be processed on existing equipment for EPS or EPP production. Especially building construction, structural and lightweight applications, where a combination of high heat resistance and good mechanical properties is required, still have a high need for suitable materials. Moreover, an important requirement of production processes for expandable materials is that residence times and temperatures be kept as short and low, respectively, as possible in order that decomposition of the material may be avoided.

We have found that bead foams combining high heat resistance with outstanding mechanical properties and good processability are obtainable on using styrene polymers which have a styrene content of 60-85% by weight and a glass transition temperature of at least 130° C., wherein the corresponding expandable pellets are produced by melt impregnation.

The present invention provides a process for producing an expandable pelletized polymeric material, comprising the steps of
a) providing a polymer component (P), consisting of
PS) 90% to 100% by weight (based on P) of a styrene polymer component having a glass transition temperature of ≧130° C., formed from
PS1) 30% to 100% by weight (based on P) of one or more styrene polymers comprising

PS11) 60% to 85% by weight (based on PS1) of polymerized styrene (PS11) or alpha-methylstyrene (PS12) or of a polymerized mixture of alpha-methylstyrene and styrene (PS13),
PS12) 15% to 40% by weight (based on PS1) of one or more than one polymerized monomer selected from the group consisting of maleic anhydride and maleimides, and
PS2) 0% to 70% by weight (based on P) of one or more styrene polymers other than PS1, comprising
PS21) 60% to 82% by weight (based on PS2) of polymerized styrene (PS11) or alpha-methylstyrene (PS12) or of a polymerized mixture of styrene and alpha-methylstyrene (PS13), and
PS22) 18% to 40% by weight (based on PS2) of polymerized acrylonitrile
and
PT) 0% to 10% by weight (based on P) of one or more thermoplastic polymers selected from the group consisting of aromatic polyethers; polyolefins; polyacrylates; polycarbonates (PC); polyesters; polyamides; polyether sulfones (PES); polyether ketones (PEK) and polyether sulfides (PES),
(b) heating the polymer component (P) to form a polymer melt,
(c) introducing from 1% to 5% by weight (based on P) of a blowing agent component (T) into the polymer melt to form a foamable melt,
(d) homogenizing the mixture,
(e) optionally adding additives to the P polymer component in one or more of steps a), b), c) and/or d),
(f) extruding the blowing agent-containing polymer melt through a die plate,
(g) pelletizing the blowing agent-containing melt in a liquid-filled chamber under a pressure of 1.5 to 20 bar to form a pelletized material.

The blowing agent components (T) can be introduced into the melt as physical blowing agent, or be formed by chemical blowing agents. The use of physical blowing agents is preferred.

The invention further provides an expandable pelletized material obtainable according to the process according to the invention, where each pellet contains per mm³ 10 or more cavities ranging in size from 1 to 200 μm and which comprises a polymer component (P), consisting of
PS) 90% to 100% by weight (based on P) of a styrene polymer component having a glass transition temperature of ≧130° C., consisting of
PS1) 30% to 100% by weight (based on P) of one or more styrene polymers each comprising
PS11) 60% to 85% by weight (based on PS1) of polymerized styrene (PS111) or alpha-methylstyrene (PS112) or of a polymerized mixture of alpha-methylstyrene and styrene (PS113),
PS12) 15% to 40% by weight (based on PS1) of one or more than one polymerized monomer selected from the group consisting of maleic anhydride and maleimides and
PS2) 0% to 70% by weight (based on P) of one or more styrene polymers other than PS1, comprising
PS21) 60% to 82% by weight (based on PS2) of polymerized styrene (PS11) or alpha-methylstyrene (PS12) or of a polymerized mixture of styrene and alpha-methylstyrene (PS13), and
PS22) 18% to 40% by weight (based on PS2) of polymerized acrylonitrile
and
PT) 0% to 10% by weight (based on P) of one or more thermoplastic polymers selected from the group consisting of aromatic polyethers, polyolefins, polyacrylates, polycarbonates (PC), polyesters, polyamides, polyether sulfones (PES), polyether ketones (PEK) and polyether sulfides (PES).

The present invention similarly provides a molding obtainable from the pelletized material of the present invention, a molded composite body comprising the molding and also to the use thereof, in particular as insulation material for technical applications and for the building sector or as structural foam element for lightweight and composite applications in the building construction industry, in wind power plants, in the automotive industry, in boat and/or shipbuilding, in furnituremaking and in the exposition industry.

The pelletized material of the present invention preferably has an average pellet size of 0.2 to 2.5 mm (analyzed by sieve analysis, determination of average particle size by assuming an RRSB distribution). Preferably, not more than 5% by weight of the pellets are less than 0.8 times the average pellet size and not more than 5% by weight are greater than 1.2 times the average pellet size.

The P polymer component preferably has a Vicat temperature (measured to ISO 306 VST/B50) in the range of over 120° C.

The styrene copolymers (PS) used as polymer component (P) according to the present invention and the thermoplastic polymers (PT) are obtainable in a manner known to a person skilled in the art, for example by free-radical, anionic or cationic polymerization in bulk, solution, dispersion or emulsion. Free-radical polymerization is preferred in the case of P1.

The PS component comprises one or more styrene copolymers PS1, comprising and preferably consisting of
PS11) 60% to 85% by weight, preferably from 60% to 97% by weight and more preferably from 65% to 95% by weight (based on PS1) of polymerized styrene (P111) or alpha-methylstyrene (P112) or a polymerized mixture of alpha-methylstyrene and styrene (P113),
PS12) 15% to 40% by weight, preferably from 3% to 35% by weight and more preferably from 5% to 30% by weight (based on PS1) of one or more than one polymerized monomer selected from the group consisting of maleic anhydride and maleimides.

Preferred maleimides are maleimide itself, N-alkyl-substituted maleimides (preferably with C₁-C₆-alkyl) and N-phenyl-substituted maleimide.

In one preferred embodiment, the PS1 component comprises from 15% to 22% by weight and preferably from 15% to 20% by weight of one or more polymerized comonomers (PS12) selected from the group consisting of maleic anhydride and maleimides.

In one preferred embodiment, the PS11 component consists of polymerized styrene (PS111).

In a further preferred embodiment, the PS11 component consists of polymerized alpha-methylstyrene (PS112). In a further preferred embodiment the PS12 component consists of a mixture of polymerized styrene (PS111) and polymerized alpha-methylstyrene (PS113).

In one preferred embodiment, the PS12 component consists of polymerized maleic anhydride and/or polymerized N-phenylmaleimide.

In one particularly preferred embodiment, the PS1 component consists of polymerized styrene PS111 and polymerized maleic anhydride or of polymerized styrene and polymerized N-phenylmaleimide or of polymerized styrene (PS111), polymerized maleic anhydride and polymerized N-phenylmaleimide.

Very particular preference for use as PS1 component is given to a copolymer consisting of 85% to 60% by weight of polymerized styrene (PS111) and 15% to 40% by weight of polymerized maleic anhydride.

In a further preferred embodiment, the PS component consists of one or more than one, preferably one, styrene copolymer (PS1).

In a further embodiment, the PS component consists of one or more than one, preferably one, styrene copolymer (PS1) and one or more than one, preferably one, styrene polymer other than PS1 (PS2).

Examples of styrene copolymers useful as component PS2) in that they are other than (PS1) are acrylonitrile-butadiene-styrene (ABS), SAN, acrylonitrile-styrene-acrylic ester (ASA). SAN (styrene-acrylonitrile) polymers are preferred. Preferred PS2) components further include terpolymers consisting of styrene, acrylonitrile and maleic anhydride.

In a further preferred embodiment, the P polymer component (and thus also the foam) comprises from 0.1% to 15% by weight and more preferably from 0.5% to 5% by weight of a thermoplastic polymer PT (all based on P).

The P polymer component optionally comprises by way of thermoplastic polymers (PT) aromatic polyethers, polyolefins, polyacrylates, polycarbonates (PC), polyesters, polyamides, polyether sulfones (PES), polyether ketones (PEK), polyether sulfides (PES) or mixtures thereof.

Polyphenylene ether (poly(oxy-2,6-dimethyl-1,4-phenylene) for example is useful as aromatic polyether (PT).

Suitable polyolefins (for use as PT component) are for example polypropylene (PP), polyethylene (PE) and polybutadiene.

A suitable polyacrylate (for use as PT component) is polymethyl methacrylate (PMMA) for example.

Suitable polyesters (for use as PT component) are for example polyethylene terephthalate (PET) and polybutylene terephthalate (PBT).

Suitable polyamides (for use as PT component) are for example nylon-6 (PA6), nylon-6,6, nylon-61 and nylon-6/6,6.

Preference for use as PT component is given to polyacrylates.

In one preferred embodiment, the P component consists of the PS component.

In one preferred embodiment, the P component consists of the PS component and the proportion of PS2 is less than 10% by weight.

The blowing agent component (T) comprises one or more blowing agents in a proportion of altogether 1% to 5% by weight, preferably 1% to 4% by weight and more preferably 2% to 4% by weight, based on (P). Examples of suitable blowing agents are aliphatic hydrocarbons having 2 to 8 and preferably 3 to 8 carbon atoms and mixtures of 2 or more such hydrocarbons and/or 2 or more isomers thereof. Halogenated hydrocarbons, nitrogen and carbon dioxide are further suitable for example. Preference is given to butane and pentane isomers, such as isobutane, n-butane, isopentane, n-pentane and mixtures thereof, more particularly pentane isomers, such as isopentane and n-pentane, and mixtures thereof. Particularly suitable for use as co-blowing agents, preferably in a proportion of 0% to 3% by weight, preferably of 0.25% to 2.5% by weight and more particularly 0.5% to 2.0% by weight (based on (P)) are (C₁-C₄)-carbonyl compounds, such as ketones and esters, C₁-C₄-alcohols and C₁-C₄-ethers. Preference for use as co-blowing agents is given to ketones.

Blowing agents such as nitrogen and carbon dioxide can also be produced through the disintegration of chemical blowing agents. In one embodiment of the invention, therefore, 0.1% to 5.0% by weight (based on P) of one or more blowing agents is additionally added. Examples of such chemical blowing agents are azodicarbonamide, sulfohydrazides such as 4,4-oxybis-benzenesulfonyl hydrazide, p-toluenesulfonyl hydrazide, benzazimides, p-toluenesulfonyl hydrazide, benzazimides, p-toluenesulfonyl semicarbazide, dinitrosopentamethylene tetramine and phenyltetrazole.

It is particularly preferable for the blowing agent component to consist of one or more pentane isomers and acetone, more particularly of 2% to 4% by weight of one or more pentane isomers and 0.5% to 3% by weight of acetone (the weight % ages being based on (P)).

The low solubility of aliphatic hydrocarbons in the PS1 styrene polymers, such as SMA, SPMI and SMAPMI, provide low bulk densities using minimal quantities of blowing agent. It is additionally advantageous to add comparatively more hydrophilic co-blowing agents which are correspondingly more soluble in the polymer matrix. The use of acetone for instance can be used to improve the fusing and hence the mechanical properties of moldings.

Bulk density for the expandable polymeric pellets of the present invention is generally not more than 700 g/l, preferably in the range from 300 to 700 g/l and more preferably in the range from 500 to 660 g/l. When fillers are used, bulk densities can result in the range from 500 to 1200 g/l depending on filler type and quantity.

In addition to polymeric (P) and blowing agent (T) components, the pelletized material used according to the present invention preferably comprises an additive component (AK). Suitable additives are known to a person skilled in the art.

In one preferred embodiment, at least a nucleating agent is added to the polymeric component (P). Examples of useful nucleating agents are finely divided, inorganic solids such as talc, silicon dioxide, mica, clay, zeolites, calcium carbonate and/or polyethylene waxes in amounts of generally 0.1% to 10% by weight, preferably 0.1% to 3% by weight and more preferably 0.1% to 1.5% by weight, based on (P). The average particle diameter of the nucleating agent is generally in the range from 0.01 to 100 μm, and preferably in the range from 1 to 60 μm. Talc is a particularly preferred nucleating agent, for example talc from Luzenac Pharma. The nucleating agent can be added by methods known to a person skilled in the art.

If desired, further additives can be added, such as fillers (for example mineral fillers, such as glass fibers), plasticizers, flame retardants, IR absorbers, such as carbon black, cokes, graphenes and/or graphite, aluminum powder and titanium dioxide, soluble and insoluble dyes, pigments, UV stabilizers and/or thermal stabilizers.

It is very particularly preferable to add graphite in amounts of generally 0.05% to 25% by weight and more preferably in amounts of 2% to 8% by weight, based on (P). Suitable particle sizes for the graphite used are in the range from 1 to 50 μm and preferably in the range from 2 to 10 μm.

The use of UV stabilizers will prove particularly advantageous. Specifically in the case of the PS1) polymers such as SMA, strong UV irradiation leads to visible yellowing and to a chemical transformation of the material that is associated with a significant degree of embrittlement. The choice of suitable UV stabilizers is decisively governed by the issue of reactivity, for example with SMA. While stabilizers based on benzotriazoles such as Tinuvin 234 are capable of improving UV stability without altering the processing and foam characteristics, stabilizers based on sterically hindered amines such as Uvinul 4050 and Tinuvin 770 are less suitable for the product system of the present invention.

The pelletized material of the present invention preferably comprises, by way of an additive, a UV stabilizer based on benzotriazoles in amounts ranging from 0.05 to 5 parts by weight and preferably from 0.1 to 1 part by weight, based on 100 parts by weight of polymer P.

Owing to the fire protection regulations in various industries, it is preferable to add one or more flame retardants. Suitable flame retardants are for example tetrabromobisphenol A, brominated polystyrene oligomers, tetrabromobisphenol A diallyl ether and hexabromocyclododecane (HBCD), more particularly the technical grade products which comprise essentially the α-, β- and γ-isomer and an addition of synergists such as Dicumyl. Preference is given to brominated aromatics, such as tetrabromobisphenol A, and brominated styrene oligomers. Examples of suitable halogen-free flame retardants are expandable graphite, red phosphorus and phosphorus compounds, such as expandable graphite, red phosphorus, triphenyl phosphate and 9,10-dihydro-9-oxa-10-phosphaphenanthrene 10-oxide.

The overall amount of additives is generally in the range form 0% to 30% by weight and preferably in the range from 0% to 20% by weight, based on the total weight of the extruded foam.

For thermal insulation purposes it is preferable to add in particular graphite, carbon black, cokes, graphenes, aluminum powder or an IR dye (e.g., indoaniline dyes, oxonol dyes or anthraquinone dyes). Graphite and carbon black are particularly preferred.

Dyes and pigments are generally added in amounts ranging from 0.01% to 30% and preferably from 1% to 5% by weight (based on P). To ensure homogeneous and microdisperse distribution of pigments in the polymer melt it can be advantageous in the case of polar pigments in particular to add a dispersing auxiliary, for example organosilanes, epoxy-containing polymers or maleic anhydride-grafted styrene polymers. Preferred plasticizers are fatty acid esters, fatty acid amides and phthalates, which can be used in amounts from 0.05% to 10% by weight, based on the polymer component P.

To produce the pelletized material of the present invention and the bead foam obtainable therefrom, the blowing agent is mixed directly into the polymer melt, preferably at elevated pressures, more particularly in the range from 20 to 500 bar and preferably at 40 to 280 bar. In addition, a polymer material already impregnated with the blowing agent can be used, which is devolatilized before the blowing agent is added or preferably is introduced into the process in a molten state together with the blowing agent. A possible process comprises the stages of a) providing the polymers, b) producing the melt, c) incorporating and mixing the blowing agents, d) homogenizing, e) optionally adding additives and f) pelletizing. Each of the a) to e) stages can be carried out by the apparatuses or apparatus combinations known in plastics processing. The polymer melt can be directly removed from a polymerization reactor, or be produced directly in the mixing extruder or a separate melting extruder by melting of polymer pellets. Static mixers or dynamic mixers, for example extruders, are suitable for mixing in the blowing agents. To set the desired melt temperature, the melt can be cooled, if desired. Suitable for this are the deployed mixing assemblies, separate coolers or heat exchangers. The pelletizing is effected by pressurized pelletization in a chamber filled with liquid and more particularly water. This serves to at least partially suppress any expansion of the blowing agent-containing melt on die exit.

To build up pressure for the dies of the pelletization, the mixing assembly (extruder) can be used as such or an additional melt assembly which builds up pressure. Preferably, a geared pump is used. Apparatus arrangements suitable for conducting the process are for example without being limited thereto:
polymerization reactor—static mixer/cooler—geared pump—pelletizer
polymerization reactor—melt extruder—geared pump—pelletizer
extruder—static mixer—pelletizer
extruder—geared pump—pelletizer
extruder—geared pump—static mixer—pelletizer
extruder—static mixer—geared pump—pelletizer
extruder—pelletizer.
extruder—static mixer—geared pump—pelletizer
extruder—geared pump—static mixer/heat exchanger—geared pump—pelletizer
extruder—static mixer—geared pump—static mixer/heat exchanger—geared
pump—pelletizer.

Preference is given to the arrangements:
extruder—geared pump—pelletizer
extruder—geared pump—static mixer—pelletizer.

A further advantageous option is melt impregnation during the extrusion step by adding the blowing agent in the extruder because in this way residence time and thermal stress on the material in the production of the pellets can be distinctly reduced.

Furthermore, the arrangement may include one or more sidearm extruders or sidearm feed systems for incorporation of further polymers and additives, for example solids or thermally sensitive addition agents. Moreover, liquid additives can be injected at every point of the process, preferably in the region of static and dynamic mixing assemblies.

The temperature at which the blowing agent-containing polymer melt is conveyed through the die plate is generally in the range from 150 to 300° C., preferably in the range from 180 to 260° C. and more preferably in the range from 190 to 230° C.

The die plate is preferably heated to not less than 10° C. above the temperature of the blowing agent-containing polymer melt in order that polymer deposits in the dies may be prevented and disruption-free pelletization may be ensured. Die plate temperature is preferably from 10 to 200° C. and more preferably from 10 to 120° C. above the temperature of the blowing agent-containing polymer melt.

Extrusion through the die plate is into a chamber filled with a liquid, preferably water. The temperature of the liquid is preferably in the range from 20 to 95° C. and more preferably in the range from 40 to 80° C.

To obtain commercially eligible pellet sizes, the diameter (D) of the die holes on the die exit side is preferably in the range from 0.2 to 2.0 mm, more preferably in the range from 0.3 to 1.5 mm and more particularly in the range from 0.3 to 1.0 mm. Pellet sizes below 2.5 mm and more particularly in the range from 0.4 to 1.5 mm are obtainable in this way in a controlled manner even after die swell.

A pelletized material according to the present invention is preferably produced by a process comprising the steps of
a) producing or providing a melt of polymer components PS) and optionally PT),
b) mixing one or more than one physical blowing agent component and optionally additives, such as water or talc, into the polymer melt by a static or dynamic mixer at a temperature of not less than 150° C.,
c) thermally homogenizing and, if appropriate, cooling the blowing agent and polymer melt to a temperature of not less than 120° C.,
d) extruding through a dieplate with drilled holes having a diameter of not more than 1.5 mm on the die exit side,
e) optionally adding additives to the P polymer component or in one or more of steps a), b) and/or c),
f) pelletizing the blowing agent-containing melt directly after the dieplate in a liquid, preferably water, at a pressure ranging from 1 to 20 bar to form a pelletized material where the pellets each contain per mm³ 10 or more cavities from 1 to 200 μm in size.

The pellets of the present invention each include per mm³ 10 or more cavities ranging from 1 to 200 μm in size.

This parameter can be actualized in a conventional manner by adjusting pelletization conditions such as die temperature, water temperature, pressure, blade speed, water throughput, optionally by performance of routine tests. The purpose here is to prevent complete foaming up of the blowing agent-containing melt, yet allow slight expansion. The preferred objective is a large number of cavities through limited, incipient foaming of pellets. In addition to pelletization parameters, the process can also be controlled via dieplate geometry and via the recipe, more particularly via the choice of matrix polymers, blowing agents and blowing agent quantities and also via additives (nucleating agents in particular).

The incipiently foamed structures make it possible to establish a cellular morphology in the expandable, blowing agent-containing pelletized material. The average cell size can be greater at the center of the beads than in the peripheral regions, the density can be higher in the peripheral regions of the beads. This makes it possible to minimize blowing agent losses as far as possible.

The incipiently foamed structures provide for a distinctly better cell size distribution and a reduction in cell size after prefoaming. In addition, the amount of blowing agent needed to achieve a minimum bulk density is lower and storage stability of the material is improved. Further achievements made possible are a distinct shortening of prefoaming times at constant blowing agent content and a distinct reduction of blowing agent quantities for constant foaming times and minimum foam densities. In addition, product homogeneity is improved by the incipiently foamed structures.

In one preferred embodiment, the expandable pellets are coated with one or more coating components optionally adsorbed on a porous solid.

Examples of suitable coating components are glycerol esters, zinc stearate and esters of citric acid.

Preference is given to the mono-, di- and triglycerides obtainable from glycerol and stearic acid, glycerol and 12-hydroxystearic acid and glycerol and ricinoleic acid, and also to mixed di- and triglycerides obtainable from one or two fatty acids selected from the group consisting of oleic acid, linoleic acid, linolenic acid and palmitic acid as well as stearic acid, 12-hydroxystearic acid and ricinoleic acid.

Particular preference is given to the corresponding commercial products which, in general, represent mixtures of appropriate mono-, di- and triesters that also may comprise small proportions of free glycerol and free fatty acids, for example glycerol tristearates or glycerol monostearates.

Preference for use as coating material is more particularly given to plasticizers selected from the group consisting of a) one or more alkyl esters of cyclohexanecarboxylic acids having a boiling point ≧160° C., b) one or more phenyl C₁₀-C₂₁-alkanesulfonates having a boiling point ≧150° C. and c) mixtures of components a) and b).

Preference for use as plasticizers a) is given to alkyl esters of cyclohexanecarboxylic

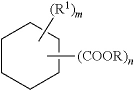

where the symbols and indices have the following meanings:

R¹ is C₁-C₁₀-alkyl or C₃-C₈-cycloalkyl; preferably C₁-C₁₀-alkyl;

m is 0, 1, 2 or 3;

n is 1, 2, 3 or 4 and

R is C₁-C₃₀-alkyl.

It is particularly preferable for the symbols and indices in formula (I) to have the following meanings:

m is 0;

n is 2 and

R is C₈-C₁₀-alkyl.

What is concerned here is more particularly diisononyl 1,2-cyclohexanedicarboxylate as marketed by BASF SE (Ludwigshafen, Germany) under the name Hexamoll® Dinch for example. Synthesis and use as plasticizer are described for example in WO99/32427 and DE 20021356.

Preference for use as plasticizer is further given to phenyl esters of (C₁₀-C₂₁)-alkyl-sulfonic acids of formula (II) (component b))

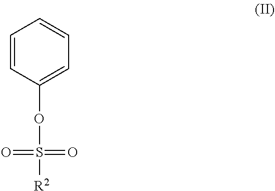

where

R² is (C₁₀-C₂₁)-alkyl and preferably (C₁₃-C₁₇)-alkyl.

Preferred plasticizers b) are mixtures of phenyl (C₁₀-C₂₁)-alkanesulfonates. Particular preference here is given to a mixture consisting of a mixture of phenyl secondary alkanesulfonates to an extent from 75 to 85% and further comprises from 15 to 25% of diphenyl secondary alkanedisulfonates and also from 2 to 3% of unsulfonated alkanes, wherein the alkyl moieties are predominantly unbranched and the chain lengths range from 10 to 21 and mainly from 13 to 17 carbon atoms.

Such mixtures are marketed for example by Lanxess AG (Leverkusen, Germany) under the Mesamoll® brands.

The amount in which the plasticizer used according to the present invention is applied to the expandable pelletized material is preferably in the range from 0.01% to 1% by weight, more preferably 0.1-0.8% by weight and even more preferably 0.2-0.5% by weight.

The coating may comprise further addition agents, such as antistats, hydrophobicizers, flame retardants, finely divided silica and inorganic fillers. The proportion of these agents depends on type and effect and is generally in the range from 0% to 1% by weight, based on coated polymeric beads, in the case of inorganic fillers.

Suitable antistats include for example compounds such as Emulgator K30 emulsifier (mixture of sodium secondary alkanesulfonates) or Tensid 743 surfactant.

The expandable pellets can be processed into foams which are in accordance with the present invention and have densities in the range from 5 to 300 kg/m³ and preferably in the range from 50 to 200 kg/m³, more preferably in the range from 70 to 150 kg/m³. The expandable pellets are prefoamed for this. This is usually accomplished by heating with steam in what are known as prefoamers. The beads thus prefoamed are then fused together to form molded articles. For this, the prefoamed beads are introduced into molds that do not close gastight and are subjected to steam. After cooling, the moldings of the present invention are demoldable.

Bead foam moldings according to the present invention preferably have a compressive strength in all three spatial directions of at least 100 kPa, preferably at least 300 kPa and especially at least 400 kPa.

The density of bead foam moldings from the pelletized material obtained according to the present invention is in general in the range from 15 to 300 g/l, preferably in the range from 50 to 200 g/l, more preferably in the range from 70 to 150 g/l. The moldings preferably have a maximum dimensional change of at most 3% on exposure to a thermal stress of 130° C. or more. Such bead foam moldings have a cell count in the range from 1 to 30 cells per mm, preferably from 3 to 20 cells per mm and more particularly from 3 to 25 cells per mm. The bead foam moldings of the present invention have a high closed-cell content in that generally more than 60%, preferably more than 70% and more preferably more than 80% of the cells of the individual foam beads are of the closed-cell type (determined to ISO 4590).

The foams and moldings of the present invention are preferably used as insulation material for technical applications and the building sector or as foam element for lightweight and composite applications, for example in automotive applications and wind power plants, especially in rotor blades of such wind power plants.

In addition to these and the abovementioned uses, a use for composite moldings in furnituremaking is preferred. For this purpose, the foam moldings of the present invention, which are in the form of a foam sheet, have one or more than one further layer applied to them by known methods familiar to a person skilled in the art.

In addition to a first layer of the foam sheet described, such composite moldings thus comprise one or more than one further layer. Preferably, the first layer is connected to one or more further layers on two surfaces at least. It is further preferable for the first layer to be connected to one or more further layers on two or more surfaces (top and bottom in the case of a rectangular cross section) and it is similarly preferable for all surfaces to be connected to one or more further layers.

In one embodiment of the invention, the construction of the composite molding consists of one or more core layers, one or more cover layers and a surface layer.

In a further embodiment of the invention, the construction of the composite molding consists of a core layer and a surface layer.

Materials useful as surface and optionally cover layer are aminoplast resin films, more particularly melamine films, PVC (polyvinyl chloride), glassfiber-reinforced plastic (GRP), for example a composite of polyester resin, epoxy resin or polyamide and glass fibers, preimpregnates, foils, laminates, for example high pressure laminate (HPL) and continuous pressure laminate (CPL), veneers, and metal coatings, more particularly aluminum coatings or lead coatings. Wovens and nonwovens are also suitable, more particularly in natural and/or manufactured fibers.

Examples of materials of a panel applied to the composite molding(s) of the present invention are all those fabricated from wood strips, wood fibers, wood shavings, woods, wood veneers, glued timber, veneers or a combination of the appropriate production processes. Preference is likewise given to paneling the molding(s) of the present invention with OSB, particle board, high density fiberboard (HDF) or medium density fiberboard (MDF), more particularly thin particleboard, HDF and MDF from 2 to 10 mm in thickness.

Useful adhesives include customary materials, for example dispersion adhesives, e.g., casein glue, epoxy resins, formaldehyde condensation resins, such as phenolic resins, urea-formaldehyde resins, melamine-formaldehyde resins, melamine-urea-formaldehyde resins, resorcinol resins and phenol-resorcinol resins, isocyanate adhesives, polyurethane adhesives and hot-melt adhesives.

The examples which follow illustrate the invention.

### EXAMPLES

Input materials:

| | |
|---|---|
| Luran ® HH120 | AMSAN with acrylonitrile content of 31% by weight |
| | and a viscosity number of 57 ml/g (commercial |
| | product of BASF SE) |
| Luran ® 3380 | SAN with acrylonitrile content of 33% by weight and |
| | a viscosity number of 80 ml/g (commercial product |
| | of BASF SE) |
| Luran ® 2580 | SAN with acrylonitrile content of 25% by weight and |
| | a viscosity number of 80 ml/g (commercial product |
| | of BASF SE) |
| Talc | IT Extra talc, Luzenac Pharma |
| 158 K | Polystyrene with a viscosity number of 93-98 ml/g |
| | (commercial product of BASF SE) |
| Tinuvin ® 234 | 2-(2H-benzotriazol-2-yl)-4,6-bis(1-methyl-1- |
| | phenylethyl)phenol, UV-absorber (commercial product |
| | of BASF SE) |

Polyphenylene ether: PX 100F (Mitsubishi Engineering Plastics)

Styrene-co-maleic anhydride (SMA); Xiran 26080 (Polyscope)

Styrene-co-maleic anhydride (SMA): Xiran 28065 (Polyscope)

Styrene-co-N-penylmaleimide (SPMI): Denka IP (Denka)

### Extrusion Process Production of Expandable Pellets on a Lab System

Expandable pellets are produced by melt impregnation. To this end, the polymers were initially plasticated in an extruder (Leistritz, screw diameter 18 mm, speed 150 rpm). The melt was impregnated with technical grade s-pentane (80% n-pentane/20% isopentane) and optionally other blowing agents such as acetone and homogenized in the extruder. The corresponding formulations are reported in the table. A melt pump at the extruder head was used to apply pressure to pelletize the material through a die plate (2 holes of 0.65 mm each) using pressurized underwater pelletization (water pressure see table, water temperature 60° C.). The average pellet size was about 1.25 mm. Total throughput was 4.5 kg/h. Melt temperature measured at die exit was about 225° C., the maximum melt temperature along the entire processing sector was 240-250° C. Average residence time was about 2.5 min.

### Mixer Process Production of Expandable Pellets on a Lab System

Expandable pellets were produced by melt impregnation using static mixing apparatuses. To this end, the polymers were initially plasticated in an extruder (Berstorff ZE40, speed 200 rpm) and metered via a melt pump into a series of static mixers and heat exchangers. At the point of entry to the first static mixer technical grade s-pentane (80% n-pentane/20% isopentane) is added, and the melt impregnated. The corresponding formulations are shown in the table. The melt temperature was then reduced via a heat exchanger and the melt temperature homogenized via a further static mixer. A melt pump at the extruder head was used to apply pressure to pelletize the material via a perforate plate (70 holes of 0.7 mm each) with a pressurized underwater pelletization (water pressure see table, water temperature 70° C.). The average pellet size was about 1.20 mm. Total throughput was 60 kg/h. Melt temperature measured at die exit was about 210° C., the maximum melt temperature along the entire processing sector was about 255° C. Average residence time was about 15 min.

### Processing and Characterizing the Expandable Pellets

Coating components used were 60% by weight of glycerol tristearate (GTS), 30% by weight of glycerol monostearate (GMS) and 10% by weight of zinc stearate, which were applied to the material after the pelletizing step.

The blowing agent-containing pelletized material was prefoamed in a pressurized prefoamer at up to 2.3 bar (absolute) to form foam beads having a density of 100-120 g/L. The prefoamed pellets were subsequently, following an intermediate storage time of 12 h, processed in an EPP molding machine at up to 3 bar (absolute) into moldings. Typical processing parameters such as prefoam time and demold time are shown in the tables which follow.

Various mechanical measurements were carried out on the moldings, including the pressure properties being determined to DIN EN 826 and the flexural strength according to DIN EN 12089. Bending energy was determined from the flexural strength measurements. Heat resistances of the materials were determined to DIN EN 1604.

Glass transition temperatures were determined to DIN ISO 11357-2 at a heating rate of 20 K/min under a protective gas (N2).

TABLE 1
Examples from extruder process

| | | | Example 1 | Example 2 | Example 3 | Example 4 | Example 5 | Example 6 |
|---|---|---|---|---|---|---|---|---|
| A1) | SMA | Xiran SZ 26080, Polyscope | 100 | | | | | 100 |
| | | Xiran SZ 28065, Polyscope | | 100 | 100 | 80 | 40 | |
| A2) | SAN | Luran 2580, BASF | | | | 20 | 60 | |
| A3) | | | | | | | | |
| B1) | blowing agent | s-pentane | 4 | 4 | 3 | 4 | 4 | 4 |
| B2) | | acetone | | | 1 | | | |
| C1) | talc | IT Extra | 0.5 | 0.5 | 0.5 | 0.5 | 0.5 | 0.5 |
| C2) | stabilizer | Tinuvin 234 | | | | | | 0.2 |

| | | | | | | |
|---|---|---|---|---|---|---|
| maximum melt temperature in production (° C.) | 250 | 250 | 245 | 245 | 250 | 250 |
| glass transition temperature (° C.) | 158 | 160 | 160 | 149 | 132 | 157 |
| water content after coating (% by weight) | <0.5 | <0.5 | <0.5 | <0.5 | <0.3 | <0.5 |
| prefoam pressure (bar) | 2.3 | 2.3 | 2.3 | 2.0 | 1.7 | 2.3 |
| max. prefoam temperature (° C.) | 135 | 135 | 135 | 130 | 125 | 135 |
| prefoam time (s) | 50 | 55 | 64 | 60 | 57 | 50 |
| bulk density after prefoaming (g/l) | 96 | 112 | 112 | 106 | 111 | 96 |
| foaming pressure in molding production (s) | 3.0 | 3.0 | 3.0 | 2.7 | 2.3 | 3.0 |
| cycle time in molding production (s) | 415 | 415 | 415 | 415 | 415 | 415 |
| molding density (g/l) | 98 | 117 | 114 | 110 | 112 | 96 |
| compressive strength (MPa) - DIN EN 826 | 1.1 | 1.3 | 1.3 | 1.2 | 1.2 | 1.1 |
| flexural strength (MPa) | 1.2 | 1.4 | 1.6 | 1.3 | 1.2 | 1.2 |
| heat resistance (° C.) - DIN 1604 | ≧150 | ≧150 | ≧150 | ≧140 | ≧120 | ≧150 |
| dimensional change <3% at temperature | | | | | | |

TABLE 2
Examples from mixer process

| | | | Example 7 | Example 8 |
|---|---|---|---|---|
| A1) | SMA | Xiran SZ 26080, Polyscope | 100 | |
| | | Xiran SZ 28065, Polyscope | | 40 |
| A2) | SAN | Luran 2580, BASF | | 60 |
| A3) | | | | |
| B1) | blowing | s-pentane | 4 | 4 |
| | agent | | | |
| B2) | | acetone | | |
| C1) | talc | IT Extra | 0.5 | 0.5 |
| C2) | stabilizer | Tinuvin 234 | 0.2 | 0.2 |

| | | |
|---|---|---|
| maximum melt temperature in production (° C.) | 255 | 255 |
| glass transition temperature (° C.) | 157 | 131 |
| water content after coating (% by weight) | <0.5 | <0.3 |
| prefoam pressure (bar) | 2.3 | 1.7 |
| max. prefoam temperature (° C.) | 135 | 125 |
| prefoam time (s) | 50 | 57 |
| bulk density after prefoaming (g/l) | 98 | 109 |
| foaming pressure in molding production (s) | 3.0 | 2.3 |
| cycle time in molding production (s) | 415 | 415 |
| molding density (g/l) | 98 | 113 |
| compressive strength MPa) - DIN EN 826 | 1.1 | 1.1 |
| flexural strength (MPa) - DIN EN 12089 | 1.2 | 1.2 |
| heat resistance (° C.) - DIN 1604 | ≧150 | ≧120 |
| dimensional change <3% at temperature | | |

1. A process for producing an expandable pelletized polymeric material, comprising the steps of:
a) providing a polymer component (P), consisting of
PS) 90% to 100% by weight (based on P) of a styrene polymer component having a glass transition temperature of ≧130° C., formed from
PS1) 30% to 100% by weight (based on P) of one or more styrene polymers comprising PS11) 60% to 85% by weight (based on PS1) of polymerized styrene (PS11) or alpha-methylstyrene (PS12) or of a polymerized mixture of alpha-methylstyrene and styrene (PS13),
PS12) 15% to 40% by weight (based on PS1) of one or more than one polymerized monomer selected from the group consisting of maleic anhydride and maleimides and
PS2) 0% to 70% by weight (based on P) of one or more styrene polymers other than PS1, comprising
PS21) 60% to 82% by weight (based on PS2) of polymerized styrene (PS11) or alpha-methylstyrene (PS12) or of a polymerized mixture of styrene and alpha-methylstyrene (PS13), and
PS22) 18% to 40% by weight (based on PS2) of polymerized acrylonitrile
and
PT) 0% to 10% by weight (based on P) of one or more thermoplastic polymers selected from the group consisting of aromatic polyethers; polyolefins; polyacrylates; polycarbonates (PC); polyesters; polyamides; polyether sulfones (PES); polyether ketones (PEK) and polyether sulfides (PES),
(b) heating the polymer component (P) to form a polymer melt,
(c) introducing from 1% to 5% by weight (based on P) of a blowing agent component (T) into the polymer melt to form a foamable melt,
(d) homogenizing the mixture,
(e) optionally adding additives to the P polymer component in one or more of steps a), b), c) and/or d),
(f) extruding the blowing agent-containing polymer melt through a die plate, and
(g) pelletizing the blowing agent-containing melt in a liquid-filled chamber under a pressure of 1.5 to 15 bar to form a pelletized material.

2. The process according to claim 1 wherein the expandable pellets have an average size in the range from 0.2 to 2.5 mm.

3. The process according to claim 2 wherein not more than 5% by weight of the pellets are less than 0.8 times the average pellet size and not more than 5% by weight are greater than 1.2 times the average pellet size.

4. The process according to claim 1 wherein the PS1) component consists of styrene and maleic anhydride.

5. The process according to claim 1 wherein the PS1) component consists of styrene and phenylmaleimide.

6. The process according to claim 1 wherein the PS1) component consists of styrene, maleic anhydride and phenylmaleimide.

7. The process according to claim 1 wherein the PS2) component consists of styrene and acrylonitrile.

8. The process according to claim 1 wherein the PS2) component consists of styrene, acrylonitrile and maleic anhydride.

9. The process according to claim 1 wherein the amount of introduced blowing agent component (T) is less than 4% by weight (based on P).

10. The process according to claim 1 wherein C₃-C₈ hydrocarbons and mixtures thereof are used as blowing agents.

11. The process according to claim 1 wherein ketones and/or alcohols are used as co-blowing agents.

12. The process according to claim 1 wherein acetone is used as co-blowing agent.

13. The process according to claim 1 wherein one or more UV stabilizers are added as an additive.

14. The process according to claim 1 wherein the liquid-filled chamber is operated at a temperature in the range from 20 to 95° C.

15. An expandable pelletized material obtainable according to the process according to claim 1, where each pellet contains per mm³ 10 or more cavities ranging in size from 1 to 200 μm and which comprises a polymer component (P), consisting of
PS) 90% to 100% by weight (based on P) of a styrene polymer component having a glass transition temperature of ≧130° C., consisting of
PS1) 30% to 100% by weight (based on P) of one or more styrene polymers each comprising
PS11) 60% to 85% by weight (based on PS1) of polymerized styrene (PS111) or alpha-methylstyrene (PS112) or of a polymerized mixture of alpha-methylstyrene and styrene (PS113),
PS12) 15% to 40% by weight (based on PS1) of one or more than one polymerized monomer selected from the group consisting of maleic anhydride and maleimides and
PS2) 0% to 70% by weight (based on P) of one or more styrene polymers other than PS1, comprising
PS21) 60% to 82% by weight (based on PS2) of polymerized styrene (PS11) or alpha-methylstyrene (PS12) or of a polymerized mixture of styrene and alpha-methylstyrene (PS13), and
PS22) 18% to 40% by weight (based on PS2) of polymerized acrylonitrile
and
PT) 0% to 10% by weight (based on P) of one or more thermoplastic polymers selected from the group consisting of aromatic polyethers, polyolefins, polyacrylates, polycarbonates (PC), polyesters, polyamides, polyether sulfones (PES), polyether ketones (PEK) and polyether sulfides (PES).

16. A molding obtainable from the expandable pelletized material according to claim 15, characterized by a density in the range from 15 to 300 g/l and a maximum dimensional change of not more than 3% on being subjected to a thermal stress of at least 130° C.

17. A molded composite body comprising the molding according to claim 16.

18. An insulation material for technical applications or the building sector or as structural foam element for lightweight and composite applications comprising a molding according to claim 16.

19. An insulation body for technical applications or the building sector or as structural foam element for lightweight and composite applications comprising a molded composite body according to claim 17.
